(19) United States
(12) Patent Application Publication
(10) Pub. No.: US 2012/0122070 A1
(43) Pub. Date: May 17, 2012

(54) ADAPTIVE COMPUTER IMPLEMENTED INSTRUCTIONAL SYSTEM

(75) Inventor: Arnold R. Cole, Hickman, NE (US)

(73) Assignee: THE GOOD NEWS BROADCASTING ASSOCIATION, INC., Lincoln, NE (US)

(21) Appl. No.: 13/297,498

(22) Filed: Nov. 16, 2011

Related U.S. Application Data
(60) Provisional application No. 61/414,326, filed on Nov. 16, 2010.
(60) Provisional application No. 61/505,185, filed on Jul. 7, 2011.

(51) Int. Cl. G09B 19/00

(52) U.S. Cl. 434/365

(57) ABSTRACT

A computer implemented instructional system for identifying an area of study for a user and increasing the user's understanding in the area is disclosed. The system includes a user information module configured to receive and store demographic and personal information about the user. A study plan generator configured to generate a set of study materials for the user based upon the information stored in the user information module is provided. A user communication module configured to send a communication to the use and a user response module configured to receive a response from the user regarding the communication is also provided. A study plan adaptor module is provided to revise the set of study materials for the user based on the user's response to the communication.

### CROSS-REFERENCE TO RELATED APPLICATIONS

The present applications claims the benefit under 35 U.S.C. §119(e) of U.S. Provisional Application Ser. No. 61/414,326, filed Nov. 16, 2010, and titled TRAINING SYSTEM, and claims the benefit under 35 U.S.C. §119(e) of U.S. Provisional Application Ser. No. 61/505,185, filed Jul. 7, 2011, and titled ADAPTIVE COMPUTER IMPLEMENTED INSTRUCTIONAL SYSTEM, both of which are herein incorporated by reference in their entirety.

### BACKGROUND

The present disclosure relates generally to the field of computer assisted instructional systems. In particular, it relates to a computer assisted instructional system having an adaptive study plan.

### DETAILED DESCRIPTION

A computer implemented instructional system for identifying an area of study for a user and increasing the user's understanding in the area may provide an adaptive study plan. The study plan may be adapted based on demonstrated knowledge of the user, the user's personal and/or demographic information, or information about events that have affected the user. A study plan may generally be the combination of a specific, pre-designed study track and supplemental study material tailored to the specific user. The supplemental study materials may include messages, additional reading, exercises, or other study content tailored to the individual user. A user information module is included to receive and store information about the user. The information may include any information that could help in crafting a study plan for the user, or that would indicate areas of study that would be most useful to the user. Such information may include, age, sex, relationship status, occupation, residence, history of significant life events, and the dates on which those events occurred. Significant life events could include, births, deaths, weddings, divorces, illnesses, graduations, changes in work or occupation, traumatic events (such as accidents, events of abuse, etc.), or other events that would inform the user's world view. Additionally, information regarding the user's knowledge of the areas of study may be used. This information may include the time the user has previously studied the material, the user's past methods of study, and the user's goals for the study plan.

Once the user information module has been provided with a first set of user information (possibly obtained through a user registration process) a study plan generator is used to select a set of study materials for the user based on the information stored in the information module. In general, the material to be studied may be arranged into pre-crafted tracks. Each track may include the same material but arranged in different orders and/or presented and worded in different ways. Based upon the information provided, the system will place the user on one of the tracks.

Once placed on a track, the system provides study materials to the user in the form of individual lessons. The pace at which the materials are provided may be selected by the user, or adjusted by the system based on the rate at which the user completes the lessons. The lessons may include reading materials and comprehension questions about the reading materials.

In parallel with the learning track, the system may provide statements of encouragement to the user based on the user's information. For example, the system may recognize, based on experience with other users, that the anniversary of certain life events or recent changes in the user's life may affect the user's study. When these events or anniversaries occur, the system may deviate from or add to the study track by providing reference to materials that are relevant to the event in question.

To determine if such events are taking place in the user's life, a user communication module may be provided. The user communication module may send communications to the user in addition to the lessons provided to the user. These communications may be used to solicit a response from the user about events occurring in the user's life, or that have occurred in the past. These responses may then be used to determine if the user should be moved from one track to another, if the pace of the study should be modulated, or if supplemental materials (such as those discussed above for purposes of encouragement) should be provided.

A user response module may be provided to receive responses to the communications. The responses may be forwarded to human study assistants or an automated system to determine what changes to the study plan should be made.

The responses may be utilized by a study plan adaptor module to revise the study materials. This revision may entail moving a user from one track to another, adjusting the pace of the lessons, or changing the type and/or frequency of communications sent to the user. The study plan adaptor may employ specific indicia of study plan success, general indicia of study plan success, or both in an effort to maximize the understanding of the user in the area of study.

Various indicia of success may include improved user comprehension of the lessons, reduced time between the sending of a communication to the user and the receipt of a user response, the frequency of user responses, etc. Specific indicia are those specific to an individual user and may be helpful to tailor the study plan to that user's preferred study habits, areas of interest, and most effective communication techniques. General indicia are those that relate to a population of users and include the same metrics. However, general indicia may be helpful in that anomalous specific indicia may be discounted. These anomalies may occur as a result of the user's mood on a particular day, unknown events that delayed a response, or other events that could skew an individual users interaction with the system. Accordingly, a combination of both specific and general indicia may be beneficial in crafting an individualized and effective study plan.

In addition to the automated communications, a personal human interaction may be very useful in enhancing the user's experience. In such systems, a user report may be automatically prepared showing specific events, trends in responses, study progress, and areas of interest. The user report may be provided to a human operator who would then send a communication to the user. Again, the communication may be through any applicable media, and may generally designed to solicit a series of responses between the operator and user in the form of a dialogue. These personal communications may be initiated at regular intervals, or at times based on user activity such as decreased or increased responses or changes in life situation. In some instances, these personal communications may be initiated at random times.

While it is apparent from the above description that the systems and methods disclosed will be useful if applied to any of a number of study areas and materials, they have been found to be particularly well suited to biblical studies.

For example, the study materials may generally include passages of the Bible for study by the user. The study plan generator may be used to select a track of biblical study. Tracks may be designed around a specific area of biblical teaching. For example, tracks may be designed that focus on financial issues, relationships with others, relationship with God, historical events of the Bible, specific areas of doctrine, etc. The user may be placed on a track based upon the user's information and areas of interest. For example, a recently divorced user may be placed on a track that focuses on relationships and healing. Another user who is a small business owner or the head of a household may be placed on a track focusing on stewardship and leadership. Yet another user with a history of financial problems or recent adverse financial events (such as the loss of a job) may be placed on a track focusing on teachings related to money. The track may also be selected based on the user's expressed interest in a study area.

The user communication module may be configured to provide communications to the user. The communications may include lessons, such as scriptural passages, quotes, artistic representations, sermons, or other communication as part of the study track. In addition, communications may be sent to solicit a response from the user. These may be designed to measure the user's comprehension of a concept or previously provided lesson.

The communications may be provided to the user by any of several media. These include email, phone calls, voicemail, SMS text messages, website comments, or direct messages through a web-based communication service such as a forum or social media network. The media used may be varied by user based on the user's preferences and the user's response history. A user may select to receive communications at a specific time of day, a time determined by information provided in the user information module, based upon geographic location of user, in conjunction with world events, at random times, or a combination thereof.

The communications may also relate to areas outside the primary area of focus for the study track. Such communications and the responses to them may be used to determine changing or transient interests of the user so that the user may be moved to another track or provided supplemental material related to these interests. The interests may be determined by specific indicia such as the number and/or frequency of user responses to communications about an area of study compared to others. General indicia may also be useful and could include information on the areas or study or specific scriptural passages found useful by other users when in similar life situations.

In addition to the automated communications, a personal human interaction may be very useful in enhancing the user's experience. In such systems, a user report may be automatically prepared showing specific events, trends in responses, study progress, and areas of interest. The user report may be provided to a human operator who would then send a communication to the user. Again, the communication may be through any applicable media, and may generally designed to solicit a series of responses between the operator and user in the form of a dialogue. These personal communications may be initiated at regular intervals, or at times based on user activity such as decreased or increased responses or changes in life situation. In some instances, these personal communications may be initiated at random times.

The responses and information about them may be used by the study plan adaptor module to determine if changes to the study plan should be made. For example, if a user becomes more responsive to passages relating to money issues, the user could be moved to a track focussing on teachings relevant to those issues. In some instances, where the user becomes more responsive to communications relating to a particular area of study, the supplemental materials (the communications) may be tailored to that area while keeping the user on their original track.

Based on the results of the study plan adaptor module, the study plan may be revised by adjusting the frequency at which scriptural passages are sent, moving the user to another track, or adjusting the frequency and type of communications sent.

What is claimed is:

1. A computer implemented instructional system for identifying an area of study for a user and increasing the user's understanding in the area, the system comprising:
a user information module configured to receive and store demographic and personal information about the user;
a study plan generator configured to generate a set of study materials for the user based upon the information stored in the user information module;
a user communication module configured to send a communication to the user;
a user response module configured to receive a response from the user regarding the communication;
a study plan adaptor module configured to revise the set of study materials for the user based on the user's response to the communication.

2. The computer implemented instructional system of claim A1, wherein the communication module is configured to deliver the communication to the user by email, voicemail, SMS text message, website comment, or direct message through a web-based communication service.

3. The computer implemented instructional system of claim A1, wherein the user response module is configured to receive the response from the user by email, voicemail, SMS text message, website comment, or direct message through a web-based communication service.

4. The computer implemented instructional system of claim A1, wherein the user information module is configured to receive and store the user's age, sex, occupation, residence, relationship status, history of significant past life events, dates of past life events.

5. The computer implemented instructional system of claim A4, wherein the user response is electronically reviewed by the study plan adaptor module.

6. The computer implemented instructional system of claim A1, wherein the communication sent to the user is configured to solicit a response from the user regarding a change in the user's demographic or personal information.

7. The computer implemented instructional system of claim A5, wherein the study plan adaptor module is configured to generate a new set of study materials based upon a user instructional need identified from the user response.

8. A method of preparing and delivering a listing of study materials to a user, the method comprising:
collecting demographic and personal information about the user;
using the information about the user to create a first list of recommended study materials to the user;
delivering at least a portion of the first list of recommended study materials to the user;
sending a communication to the user, the communication configured to solicit a response from the user regarding the user's demographic or personal information;
receiving a response from the user, the response including an update on the users demographic or personal information;
generating a second list of recommended study materials for the user; and
delivering at least a portion of the second list of recommended study materials to the user.
